(19) United States
(12) Patent Application Publication
(10) Pub. No.: US 2007/0192484 A1
(43) Pub. Date: Aug. 16, 2007

(54) Distributed authentication system and communication control apparatus

(75) Inventors: Ryouji Yamaoka, Mitaka (JP); Kazuhiko Sagara, Kodaira (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/338,724

(22) Filed: Jan. 25, 2006

(30) Foreign Application Priority Data
Mar. 17, 2005 (JP) 2005-77087

(51) Int. Cl. G06F 15/173

(52) U.S. Cl. 709/225

(57) ABSTRACT

Provided is a distributed authentication system and a communication control apparatus which allow a user to use a service with retained security. The distributed authentication system includes: a terminal; a communication control apparatus; and a server for distributing a service, the terminal, the communication control apparatus, and the server being connected to one another through a communication network, the communication control apparatus controlling communication between the terminal and the server, and in the system: the communication control apparatus includes a judgment module for judging whether to approve an access request from the terminal to the server; and the judgment module calculates a security level for the access request, requests the terminal to retrieve detailed information corresponding to the calculated security level, and approves the access request by authenticating the terminal of an access request source based on the detailed information received from the terminal.

### CLAIM OF PRIORITY

The present application claims priority from Japanese application P2005-077087 filed on Mar. 17, 2005, the content of which is hereby incorporated by reference into this application.

### BACKGROUND

This invention relates to a distributed authentication system and a communication control apparatus which allow a user to use a service with retained security.

A network system is known to have a configuration including a terminal and a plurality of service distributors, in which the terminal transmits an access request to each service distributor. Upon receiving the access request from a user of the terminal, the service distributor requests an authentication server, which is connected to the service distributor, to authenticate the user. When having authenticated the user as eligible, the authentication server issues a notification to that effect to the terminal. Then, the service distributor distributes a service to the terminal.

When the user of the terminal uses services provided by a plurality of service distributors, it is required to perform authentication processing for each service distributor in order to retain security. Therefore, it is required for the user to perform different complicated authentication processing for each service.

Also, there exists a system which employs a network to group a plurality of users and provide various kinds of services. Further, there exists a system in which recommended information or service is provided to an individual user according to a preference or behavior history of the user.

For instance, a single sign-on authentication method is known, in which a first authentication processing and a second authentication processing are carried out (see JP 2002-335239 A, for instance). In the first authentication processing, a first authentication server having received a content request from an authentication client terminal operated by a user carries out authentication of the user, holds an authentication state that is a result of the execution of the authentication, and creates and issues an authentication token showing the authentication state, while in the second authentication processing, a second authentication server having received the content request from the authentication client terminal operated by the user performs processing concerning the authentication of the user using the authentication token created and issued in the first authentication processing.

Also, a path extraction apparatus is known which, has network topology information, network resource information, service attribute information in which service attributes are set, and network attribute information in which network attributes are set, selects a network suited for a service based on the service attribute information and the network attribute information, and obtains path information in the selected network based on the network topology information and the network resource information (see JP 2004-260671 A, for instance).

### SUMMARY

According to the technique described in JP 2002-335239 A, however, it is impossible to provide an, optimum authentication scheme with which optimum security is retained according to a user and a service. Also, with the technique described in JP 2004-260671 A, it is possible to select a network suited for a service using the attribute information but it is impossible to provide optimum security.

In addition, there is a problem in that a user is required to carry out various settings and complicated authentication processing for each service that he/she wants to use, which lowers user convenience. Desired is a system capable of providing an environment having a network in which many information terminals perform communication, which allows use of a service through simple settings and authentication processing while retaining security suited for the service. With the conventional techniques, however, security is retained by performing authentication processing for each service at an individual server and it is not guaranteed that optimum authentication means is determined.

It is therefore an object of this invention to judge a security level with reference to service content information and user context information and provide a user with an authentication scheme that is optimum to retain security corresponding to the security level. It is another object of this invention to, when a terminal of the user has moved, allow the user to continuously use a service with safety without performing another authentication processing.

In order to solve the above problem, according to this invention, there is provided a distributed authentication system includes: a terminal; a communication control apparatus; and a server for distributing a service, the terminal, the communication control apparatus, and the server being connected to one another through a communication network, the communication control apparatus controlling communication between the terminal and the server, and in the system: the communication control apparatus includes a judgment module for judging whether to approve an access request from the terminal to the server; and the judgment module calculates a security level for the access request, requests the terminal to retrieve detailed information corresponding to the calculated security level, and approves the access request by authenticating the terminal of an access request source based on the detailed information received from the terminal.

According to an embodiment of this invention, by applying authentication means suited for a service designated by an access request from a terminal, it becomes possible to retain security corresponding to circumstances. Also, it becomes possible to allow a user to use a service with safety without performing complicated authentication processing.

### BRIEF DESCRIPTION OF THE DRAWINGS

FIG. 1 is a construction diagram of a distributed authentication system according to a first embodiment of this invention.

FIG. 2 is a block diagram of a construction of a communication control apparatus according to the first embodiment of this invention.

FIG. 3 is an explanatory diagram of an example of a user context information according to the first embodiment of this invention.

FIG. 4 is an explanatory diagram of an example of a service content information according to the first embodiment of this invention.

FIG. 5 is an explanatory diagram of an example of a user authentication processing information according to the first embodiment of this invention.

FIG. 6 is an explanatory diagram of a judgment table according to the first embodiment of this invention.

FIG. 7 is a sequence diagram of authentication processing according to the first embodiment of this invention.

FIG. 8 is another sequence diagram of the authentication processing according to the first embodiment of this invention.

FIG. 9 is a flowchart of processing executed by the communication control apparatus according to the first embodiment of this invention.

FIG. 10 is a flowchart of processing executed by a terminal according to the first embodiment of this invention.

FIG. 11 is a construction diagram of a distributed authentication system according to a second embodiment of this invention.

FIG. 12 is a sequence diagram of authentication processing according to the second embodiment of this invention.

FIG. 13 is another sequence diagram of the authentication processing according to the second embodiment of this invention.

FIG. 14 is a flowchart of processing executed by a communication control apparatus according to the second embodiment of this invention.

FIG. 15 is a construction diagram of a distributed authentication system according to a third embodiment of this invention.

FIG. 16 is a sequence diagram of authentication processing according to the third embodiment of this invention.

FIG. 17 is another sequence diagram of the authentication processing according to the third embodiment of this invention.

FIG. 18 is a construction diagram of a distributed authentication system according to a fourth embodiment of this invention.

FIG. 19 is a sequence diagram of authentication processing according to the fourth embodiment of this invention.

FIG. 20 is a construction diagram of a distributed authentication system according to a fifth embodiment of this invention.

FIG. 21 is another construction diagram of the distributed authentication system according to the fifth embodiment of this invention.

### DETAILED DESCRIPTION OF THE PREFERRED EMBODIMENTS

Hereinafter, distributed authentication systems according to embodiments of this invention will be described with reference to the accompanying drawings.

### First Embodiment

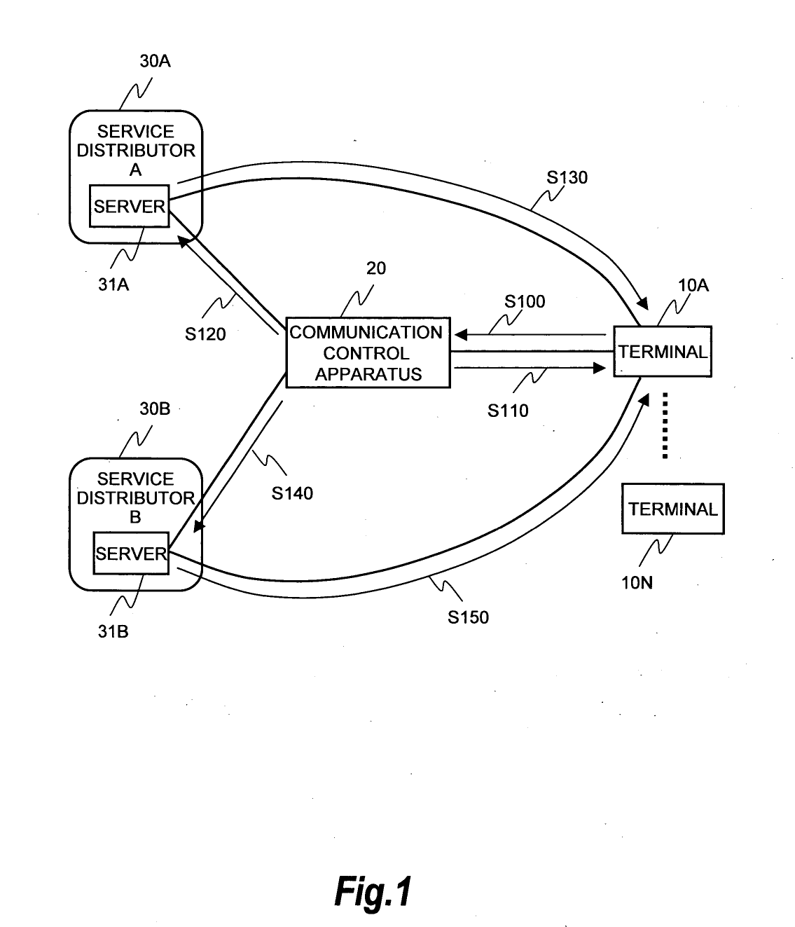

FIG. 1 is a construction diagram of the distributed authentication system according to the first embodiment of this invention.

In the distributed authentication system of this embodiment, a terminal 10 (10A to 10N), communication control apparatuses 20, and a server (31A and 31B) of a service distributor 30 (30A and 30B) are connected through a communication network (network).

In each of the terminals 10A to 10N, a program that operates according to instructions from a user has been installed. This program requests service distributed by the service distributor 30A or 30B connected through the network. It should be noted that in the distributed authentication system of this embodiment, N terminals are connected and operate but in the following description, only an operation of the terminal 10A will be described for ease of explanation.

The communication control apparatus 20 receives an access request from the terminal 10A and carries out authentication processing corresponding to the request from the terminal 10A. When having authenticated the terminal 10A as eligible, the communication control apparatus 20 issues a notification to the service distributor 30A or 30B for which the access request has been issued.

The servers 31A and 31B of the service distributors 30A and 30B distribute service requested by the terminal 10A. These servers 31A and 31B each include a program and provide the terminal 10A with the content of the service through the network.

It should be noted that in the distributed authentication system in this embodiment, the terminal 10A, the communication control apparatus 20, and the servers 31A and 31B are connected to each other through the network but a construction may be used instead in which they are connected to each other through a wide-area network such as the Internet.

An operation of this distributed authentication system will be described. When the terminal 10A requests the content of the service distributed by the service distributor 30A, the following processing is carried out.

First, the terminal 10A transmits an access request to the communication control apparatus 20 (S100). This access request contains information about the terminal 10A, information about a user of the terminal 10A, and information about the requested content. Upon receiving the access request from the terminal 10A, the communication control apparatus 20 performs authentication processing based on the information about the terminal, the information about the user, and the information about the requested content contained in the request. When having authenticated the terminal 10A as eligible, the communication control apparatus 20 delivers a policy to the server 31A of the service distributor 30A (S120). This policy contains information about the content of the service requested by the user, a notification showing that the user has already been authenticated as eligible, and the address of the terminal 10A that issued the request.

The server 31A receives the delivered policy and refers to the contents of the policy. Then, the server 31A distributes the content of the service to the terminal 10A that issued the request (S130).

On the other hand, when it is impossible to authenticate the terminal 10A as eligible only with the information contained in the access request from the terminal 10A, the communication processing apparatus 20 requests the terminal 10A to further transmit detailed information (S110). This detailed information contains information for authentication such as a password.

Upon receiving the request for the detailed information transmission, the terminal 10A transmits the detailed information to the communication processing terminal 20. Upon receiving the detailed information from the terminal 10A, the communication processing terminal 20 performs authentication processing based on the information contained in the detailed information. As a result, when having authenticated the terminal 10A as eligible based on the information, the communication control apparatus 20 delivers a policy to the server 31A of the service distributor 30A (S120). Upon receiving the delivered policy, the server 31A distributes the content of the service to the terminal 10A (S130).

Also, following this, when the content of service provided by the service distributor 30B are desired, the terminal 10A transmits an access request to the communication control apparatus 20 in a like manner (S100). The communication control apparatus 20 performs authentication processing with reference to information contained in the received access request and information about the authentication processing that the terminal 10A has already carried out. When having authenticated the terminal 10A as eligible, the communication control apparatus 20 delivers a policy to the server 31B of the service distributor 30B like in the case described above (S140). Upon receiving the delivered policy, the server 31B distributes the content of the service to the terminal 10A (S150).

On the other hand, when it is impossible to authenticate the terminal 10A as eligible only with the information contained in the access request from the terminal 10A, the communication control apparatus 20 requests the terminal 10A to further transmit detailed information (S110). Then, like in the case described above, the communication control apparatus 20 performs authentication processing based on the detailed information transmitted from the terminal 10A. Following this, when having authenticated the terminal 10A as eligible, the communication control apparatus 20 delivers a policy to the server 31B of the service distributor 30B (S140). Upon receiving the delivered policy, the server 31B distributes the content of the service to the terminal 10A (S150).

It should be noted that in this case, when the terminal 10A has already been authenticated as eligible in response to an access request and when a security level of an access request issued after the access request is lower than a security level of the preceding access request, the communication control apparatus 20 approves the succeeding access request without requesting the detailed information.

As a result of this series of processing, it becomes unnecessary for the user of the terminal 10A to send inquiries to the servers of the service distributors and perform authentication processing for respective contents of requested service. In other words, it becomes possible for the terminal 10A to use the contents of a plurality of kinds of services merely by issuing access requests to one communication control apparatus 20. In order to realize this, the communication control apparatus 20 receives all access requests from the terminal 10A and delivers policies to the servers 31A of the service distributors 30A when the terminal has been authenticated as eligible. Upon receiving the delivered policies, the servers 31A of the service distributors 30A distribute the content of the service to the terminal 10A.

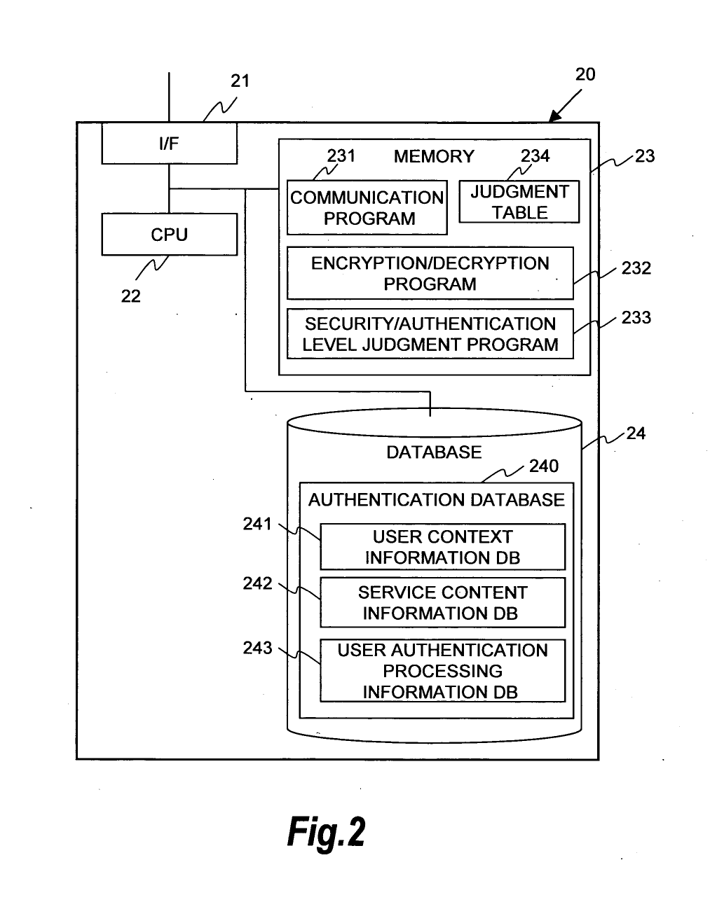

FIG. 2 is a block diagram of a construction of the communication control apparatus 20.

The communication control apparatus 20 includes an interface (I/F) 21, a CPU 22, a memory 23, and a database 24.

The I/F 21 receives a request from another apparatus connected through the network and sends a result thereof.

The CPU 22 reads various programs stored in the memory 23 and executes the programs.

The memory 23 is constructed by a storage such as a DRAM. In the memory 23, a communication program 231, an encryption/decryption program 232, a security/authentication level judgment program 233, and a judgment table 234 are stored.

The communication program 231 analyzes data received by the I/F 21.

The encryption/decryption program 232 encrypts data to be transmitted through the I/F 21 and decrypts encrypted data received through the I/F 21.

The security/authentication level judgment program 233 judges whether authentication of the content requested by the terminal 10A should be permitted with reference to the information contained in the access request transmitted from the terminal 10A and an authentication database 240 stored in the database 24.

The judgment table 234 is a table for judging an authentication level obtained from an authentication level of the user of the terminal 10A that transmitted the access request and an authentication level of the content designated by the access request. This judgment table 234 is used by the security/authentication level judgment program 233.

The database 24 comprises a storage device such as a hard disk drive. In the database 24, the authentication database 240 is stored. This authentication database 240 contains a user context information database (DB) 241, a service content information database (DB) 242, and a user authentication processing information database (DB) 243.

The user context information database 241 stores information about users who use service.

The service content information database 242 stores information about the content of the service distributed by the service distributors 30A and 30B.

The user authentication processing information database 243 stores the state (progress, result, or the like) of authentication performed by the security/authentication level judgment program 233 in response to the access request from the terminal 10A.

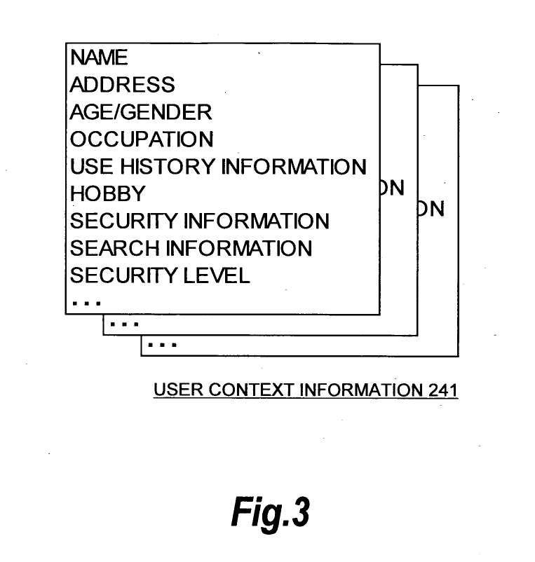

FIG. 3 is an explanatory diagram of an example of the user context information database 241.

The user context information database 241 stores a piece of user information for each registered user. Each piece of user information gives the “name”, “address”, “age”, “occupation”, “hobby”, and the like of a corresponding user, for instance. In addition, the piece of user information shows the security level of the corresponding user. The security level is a value showing the trustworthiness of the user. For instance, the security level is set high when the user was registered recently or caused trouble in the past and his/her trustworthiness is low. On the other hand, when the user uses service without causing trouble for a predetermined period of time or more after registration, the security level is set low. The security level is determined by the service distributor 30, for instance.

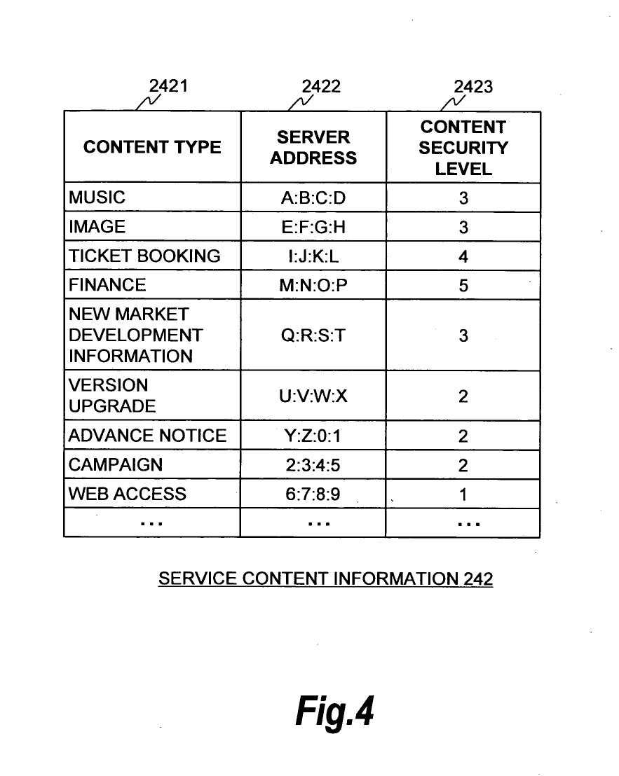

FIG. 4 is an explanatory diagram of an example of the service content information database 242.

The service content information database 242 stores information about the service distributed by the service distributors. The service content information database 242 includes a content type column 2421, a server address column 2422, and a content security level column 2423. The content type column 2421 stores content type information such as “music”, “image”, and “ticket booking”. The server address column 2422 stores the addresses of servers that provide contents of service. The content security level column 2423 stores security levels set for the contents. For instance, in the case of “finance” service that requires a high level of security, the maximum value “5” is set in the security level column 2423. Also, in the case of “Web access” service that does not require a high level of security, the minimum value “1” is set in the security level column 2423.

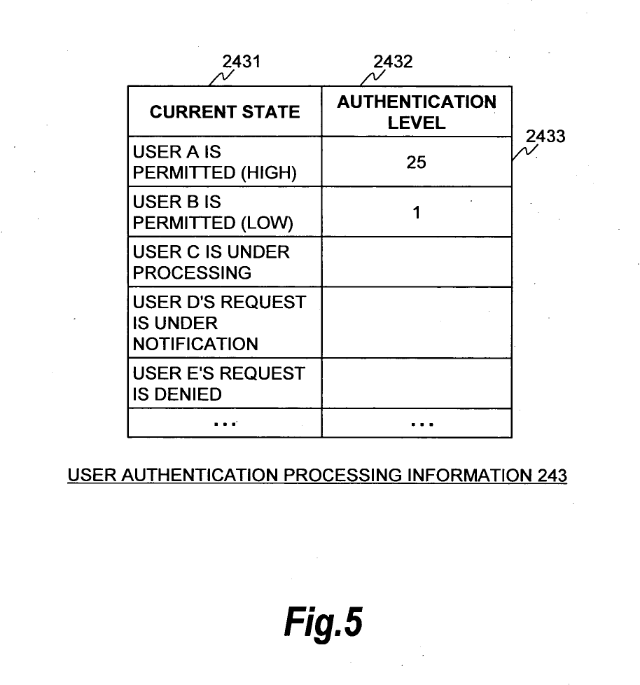

FIG. 5 is an explanatory diagram of an example of the user authentication processing information database 243.

The user authentication processing information database 243 stores the states (progresses, results, and the like) of authentication performed by the security/authentication level judgment program 233 in response to access requests from the terminals 10A. The user authentication processing information database 243 includes a current state column 2431 and an authentication level column 2432.

The current state column 2431 stores the current authentication states of users of the terminals 10A that has transmitted the access requests to the communication control apparatus 20. The authentication level column 2432 stores identifiers indicating the authentication levels of users who have been authenticated as eligible. For instance, in the case of user “A”, “User A is permitted” is stored in an entry 2433 of the current state column 2431 and “25” is stored in an entry 2433 of the authentication level column 2432. In other words, it can be understood that the user “A” has already been authenticated as eligible in response to his/her access request. Also, it can be understood that the authentication level of the user “A” is “25”.

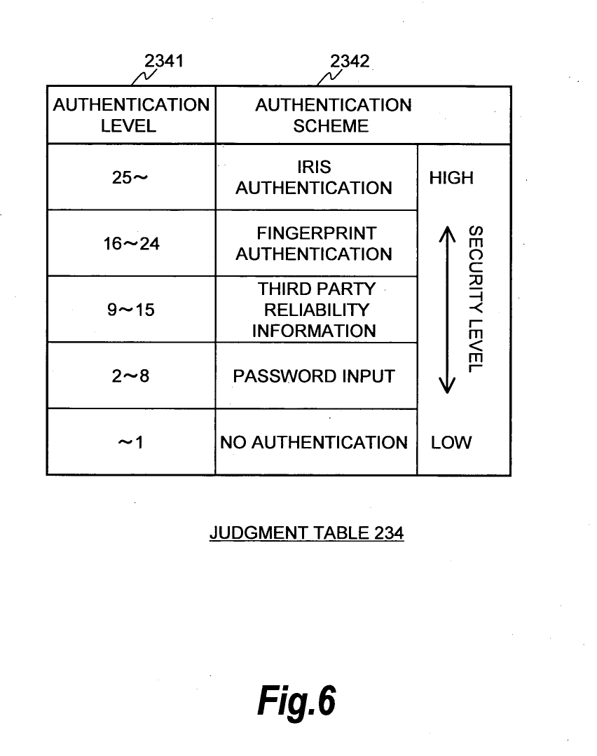

FIG. 6 is an explanatory diagram of the judgment table 234.

As described above, the judgment table 234 is a table used by the security/authentication level judgment program 233 to judge the authentication levels. The judgment table 234 includes an authentication level column 2341 and an authentication scheme column 2342.

The security/authentication level judgment program 233 calculates products of the security levels of the users and the security levels of the content of service requested by the users and judges to which authentication level ranges in the authentication level column 2341 the calculated values belong. Then, the security/authentication level judgment program 233 finds authentication schemes corresponding to the authentication level ranges from the authentication scheme column 2342.

The security levels of the users are acquired from the user context information database 241. Also, the security levels of the content of the service are acquired from the service content information database 242.

Upon receiving an access request from the terminal 10A, the security/authentication level judgment program 232 of the communication control apparatus 20 acquires information about the user and information about the content of service from information contained in the access request. Then, the security/authentication level judgment program 232 refers to the user context information database 241 and acquires a value of the security level of the user. Also, the security/authentication level judgment program 232 refers to the service content information database 242 and acquires a value of the security level of the content of the service designated by the request. Then, the security/authentication level judgment program 232 calculates a product of the acquired user security level value and content security level value and selects an authentication scheme with reference to a value of the product.

For instance, when the content of the service requested by the user are “Web access”, the value of the security level of the content is “1”, and the value of the security level of the user is “1”, the authentication level becomes “1” that is a product of the security level values. The security/authentication level judgment program 232 refers to the judgment table 234 using this authentication level “1” as a key and selects “no authentication” from the authentication scheme column 2342. As a result, the user is permitted to use the “Web access” service in response to the access request without performing authentication processing.

It should be noted that in the case of an ordinary user who uses service frequently and caused no trouble in the past, the security level in the user context information is set at “1” because his/her trustworthiness is highest (security is lowest). Also, in the case of the “Web access”, it is not required to consider special security, so the security level is set at “1”.

Also, when the content information of the requested service is “finance” service, the value of the security level of the content is “5”, and the value of the security level of the user is “5”, the authentication level becomes “25” that is a product of the security level values. The security/authentication level judgment program 232 refers to the judgment table 234 using this authentication level “25” as a key and selects “iris authentication scheme” from the authentication scheme column 2342. The communication control apparatus 20 issues a request designating the iris authentication to the terminal 10A. When the user has been authenticated as eligible as a result of the iris authentication, he/she is permitted to access the “finance” service.

It should be noted that for each user who requested service for the first time, the security level of the user context information is set at “5” because his/her trustworthiness is lowest (security is highest).

By stepwisely changing the levels of security of authentication, which the users are requested to perform, according to the products of the security levels of the users and the security levels of the content of the service requested by the users in the manner described above, it becomes possible to request the users to use authentication schemes, with which it is possible to retain high levels of security, in the case of access requests to service which requires high levels of security.

Next, an operation of the distributed authentication system of this embodiment will be described.

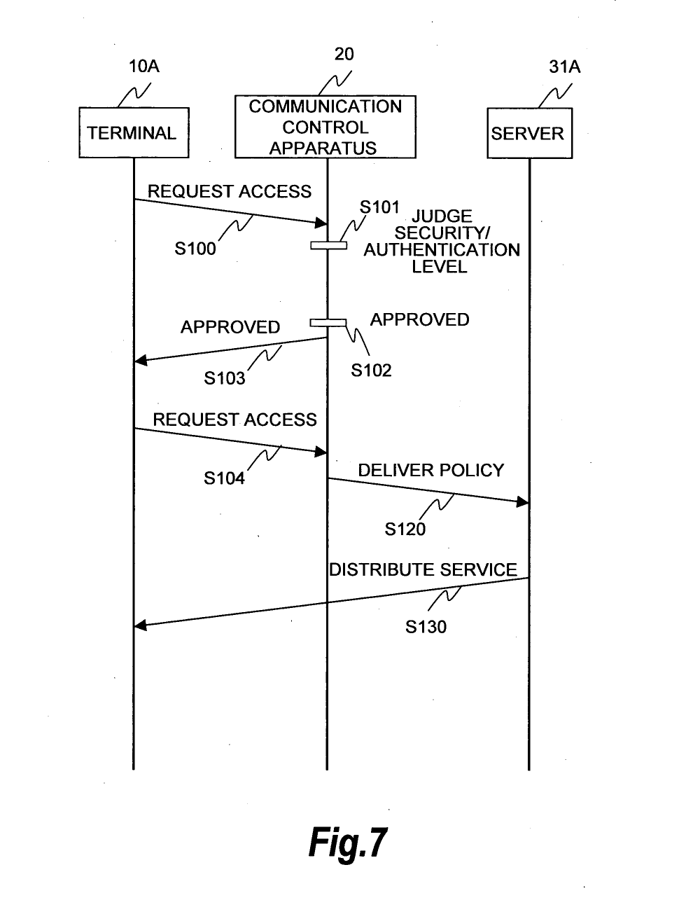

FIG. 7 is a sequence diagram of authentication processing according to this embodiment.

The sequence diagram of FIG. 7 shows processing in the case of service whose authentication level is low and which the user is capable of accessing without performing authentication.

The terminal 10A transmits an access request to the communication control apparatus 20 (S100). This access request contains information about the user of the terminal 10A, information about the content of service for which the access request has been issued, and the like.

The communication control apparatus 20 receives the access request through the I/F 21. The communication program 231 receives this access request, analyzes the contents thereof, and sends the request to the security/authentication level judgment program 233. The security/authentication level judgment program 233 judges whether the access should be permitted with reference to the contents of the access request (S101).

When the security/authentication level judgment program 233 has approved the access request from the user without requesting detailed information (S102), the communication program 231 transmits a notification showing that the access request has been approved to the terminal 10 through the I/F 21 (S103).

Upon receiving this access request approval, the terminal 10A transmits an access request to the communication control apparatus 20 (S104).

Upon receiving the access request from the user of the terminal 10A that has already been authenticated as eligible, the communication control apparatus 20 delivers a policy to the server 31A of the service distributor 30A (S120). Upon receiving the policy, the server 31A of the service distributor 30 distributes the service to the terminal 10A according to the contents of the policy (S130).

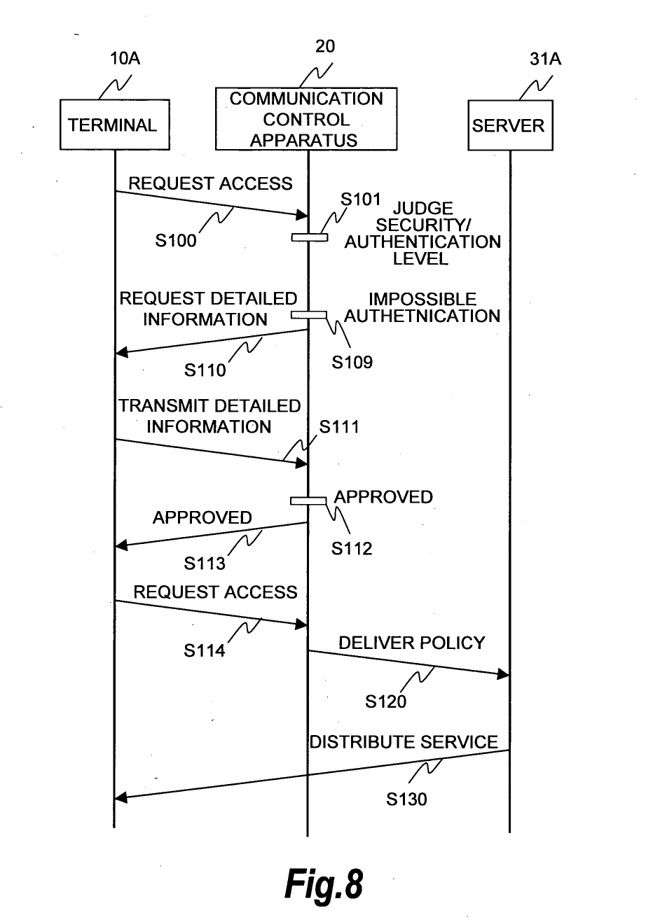

FIG. 8 is another sequence diagram of the authentication processing according to this embodiment.

The sequence diagram of FIG. 8 shows processing in the case of service whose authentication level is high and which requires detailed information for authentication.

The terminal 10A transmits an access request to the communication control apparatus 20 (S100). This access request contains information about the user of the terminal 10A, information about the content of service for which the access request has been issued, and the like.

The communication control apparatus 20 receives the access request through the I/F 21. The communication program 231 receives this access request, analyzes the contents, thereof, and sends the request to the security/authentication level judgment program 233. The security/authentication level judgment program 233 judges whether the access should be permitted with reference to the received contents of the access request (S101).

When the security/authentication level judgment program 233 has judged that it is impossible to approve the access request from the user and detailed information is required (S109), the communication program 231 transmits a detailed information request to the terminal 10A through the I/F 21 (S110).

Upon receiving this detailed information request approval, the terminal 10A transmits an detailed information to the communication control apparatus 20 (S111).

Upon receiving this detailed information, the security/authentication level judgment program 233 of the communication control apparatus 20 refers to the contents of the detailed information and judges whether the access by the user should be permitted. Following this, when the access request from the user has been approved (S112), the communication program 231 transmits a notification showing that the access request has been approved to the terminal 10A through the I/F 21 (S113).

Upon receiving this access request approval, the terminal 10A transmits this access request to the communication control apparatus 20 (S114).

Upon receiving the access request from the user of the terminal 10A that has already been authenticated as eligible, the communication control apparatus 20 delivers a policy to the server 31A of the service distributor 30A (S120). This policy contains information about the content of the service requested by the user, a notification showing that the user has already been authenticated as eligible, and the address of the terminal 10A that issued the request. Upon receiving the policy, the server 31A distributes the service to the terminal 10A according to the contents of the policy (S130).

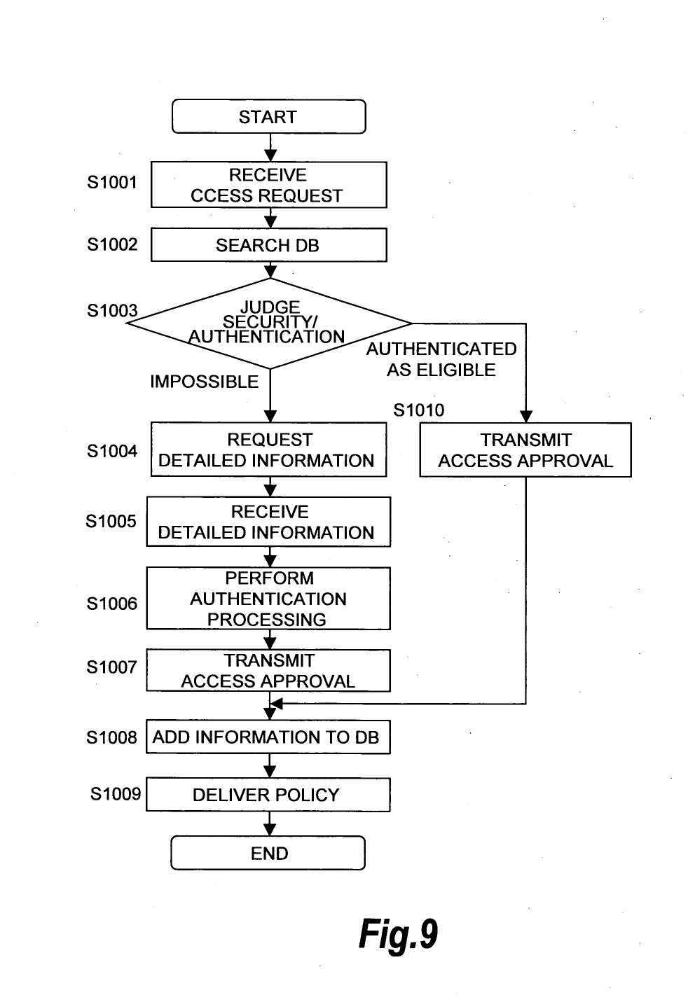

FIG. 9 is a flowchart of processing by the communication control apparatus 20.

The communication control apparatus 20 receives an access request from the terminal 10 (S1001). This access request is sent to the communication program 231 through the I/F 21. The communication program 231 analyzes the contents of the received access request and passes the access request to the security/authentication level judgment program 233.

The security/authentication level judgment program 233 acquires information about a user, who issued the access request, and information about a content from the received access request. Then, the security/authentication level judgment program 233 searches the user context information database 241 of the authentication database 240 and acquires information about the user. Also, the security/authentication level judgment program 233 searches the service content information database 242 of the authentication database 240 and acquires information about the content (S1002).

The security/authentication level judgment program 233 calculates a product of a value of a security level of the user and a value of a security level of the content. Then, the security/authentication level judgment program 233 selects an authentication method, which is suited for the access request, with reference to the calculated value and the judgment table 234 (S1003).

When the access request has been approved without performing authentication based on detailed information from the terminal 10A (when the calculated value is “1”, for instance), a notification showing that the access request has been approved is transmitted to the terminal 10A (S1010).

On the other hand, when it is impossible to approve the access request without performing authentication based on detailed information from the terminal 10A (when the calculated value is “2” or more, for instance), in S1003, detailed information corresponding to the selected authentication scheme 2342 is requested. For instance, when the selected authentication scheme is “password input”, a registered user name and password are requested. Therefore, the communication control apparatus 20 transmits a detailed information request to the terminal 10A (S1004). More specifically, the security/authentication level judgment program 233 sends a detailed information request to the communication program 231. The communication program 231 transmits the received detailed information request to the terminal 10A through the I/F 21.

Upon receiving the detailed information request, the terminal 10A transmits detailed information corresponding to the request to the communication control apparatus 20. For instance, when the authentication scheme is “password input”, a program of the terminal 10A prompts the user to input his/her user name and password. Upon receiving the input from the user, the terminal 10A transmits the detailed information to the communication control apparatus 20.

The communication control apparatus 20 receives the detailed information from the terminal 10A. This detailed information is sent to the communication program 231 through the I/F 21. The communication program 231 analyzes the contents of the detailed information and sends the information to the security/authentication level judgment program 233.

Upon receiving the detailed information (S1005), the security/authentication level judgment program 233 carries out authentication processing based on the information (S1006). More specifically, the security/authentication level judgment program 233 authenticates the detailed information against information prestored in the database 24 based on the authentication scheme selected in step S1003.

When having approved the access request, the security/authentication level judgment program 233 transmits a notification showing that the access request has been approved to the terminal 10A (S1007).

When having approved the access request in step S1007 or step S1010, the security/authentication level judgment program 233 registers the user authenticated as eligible and a corresponding authentication level in the user authentication processing information database 243 of the authentication database 240 (S1008).

Next, the security/authentication level judgment program 233 delivers a policy to the server 31 of the content provider 30A that provides the content requested by the user of the terminal 10A (S1009). Upon receiving the policy, the server 31A provides the terminal 10A with the content of the service according to the contents of the policy.

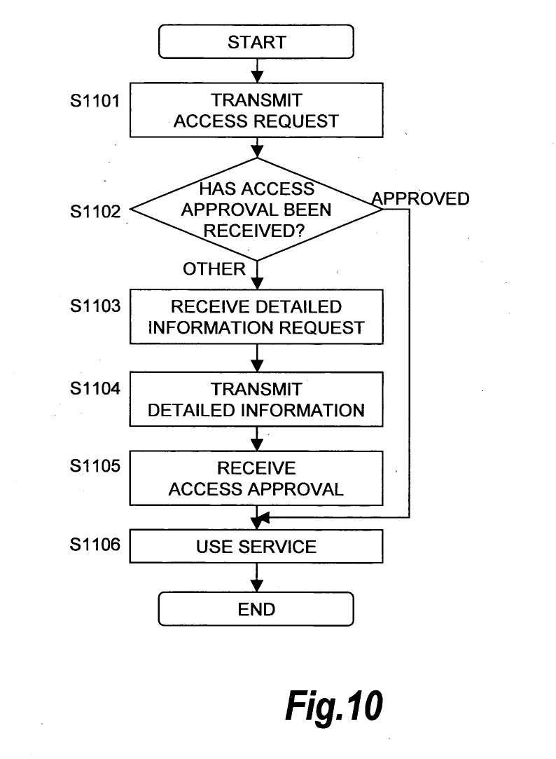

FIG. 10 is a flowchart of processing by the terminal 10A.

The terminal 10A transmits an access request to the communication control apparatus 20 in order to receive distribution of the content of service requested by the user (S1101).

The terminal 10A judges whether it has received an access request approval notification from the communication control apparatus 20 as a response to the access request (S1102).

When the terminal 10A has received the access request approval notification, the requested service is distributed from the server 31A of the service distributor 30A and it becomes possible to use the service (S1106).

On the other hand, when it is impossible to approve the access request, the communication control apparatus 20 transmits a detailed information request. The terminal 10A receives this detailed information request (S1103). Then, the terminal 10A transmits the detailed information corresponding to the request to the communication control apparatus 20 (S1104). For instance, in the case of an authentication scheme “password input”, the program of the terminal 10A prompts the user to input his/her user name and password. Then, the terminal 10A receives the input by the user and transmits the detailed information to the communication control apparatus 20.

When the terminal 10A has received the access request approval notification from the communication control apparatus 20 as a result of the transmission of the detailed information (S1105), the requested service is distributed from the server 31A of the service distributor 30A and it becomes possible to use the service (S1106).

As described above, in the first embodiment of this invention, when requesting the service distributed by the service distributor 30A, the terminal 10A transmits an access request to the communication control apparatus 20. The communication control apparatus 20 receives the access request and judges whether the terminal 10A is permitted. When having authenticated the terminal 10A as eligible, the communication control apparatus 20 issues a notification to the terminal 10A and delivers a policy. to the service distributor 30A. With this construction, it becomes possible for the terminals 10 to use the content of the service distributed by the service distributors 30 only by performing authentication processing with respect to the communication control apparatus 20. As a result, it becomes unnecessary for the terminals 10 to issue authentication requests to the respective service distributors.

### Second Embodiment

Next, a distributed authentication system according to a second embodiment of this invention will be described.

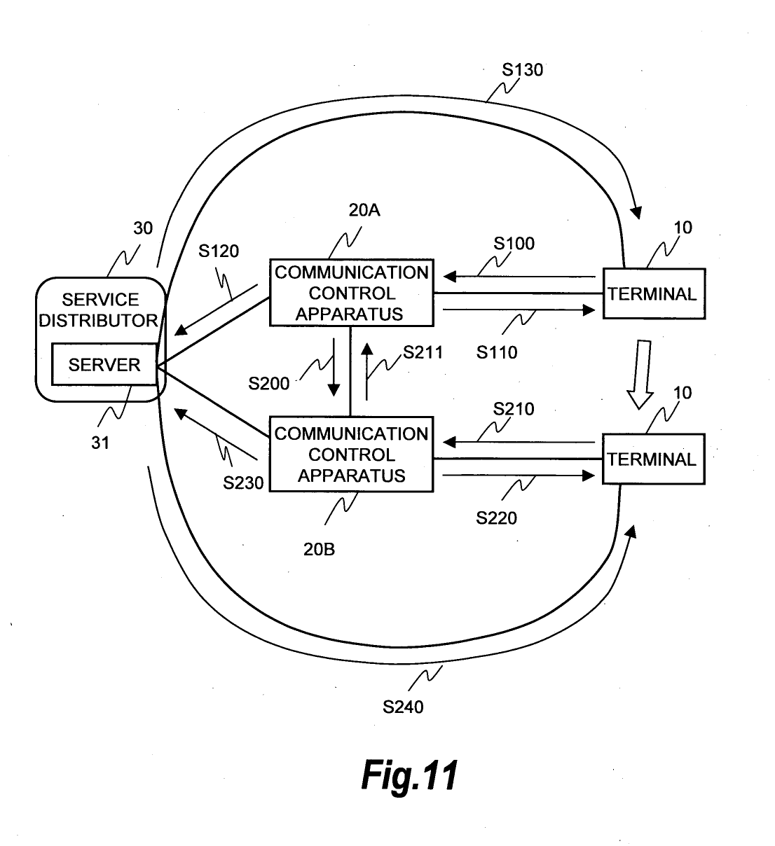

FIG. 11 is a construction diagram of the distributed authentication system according to the second embodiment of this invention.

In the distributed authentication system of this embodiment, a terminal 10, communication control apparatuses 20 (20A and 20B), and a server 31 of a service distributor 30 are connected to each other through a network.

It should be noted that the terminal 10, the communication control apparatuses 20 (20A and 20B), and the server 31 of the service distributor 30 are the same as those of the first embodiment described above, so the description thereof will be omitted.

Also, the terminal 10 is constructed so that it is movable and is capable of connecting to and communicating with each of the communication control apparatuses 20A and 20B.

An operation of the distributed authentication system of the second embodiment will be described.

Processing in the case where the terminal 10 requests the content of service distributed from the server 31 of the service distributor 30 is the same as that of the first embodiment described above.

In other words, the terminal 10 transmits an access request to the communication control apparatus 20A (S100). This access request contains information about the terminal 10, information about a user of the terminal, and information about the requested content. Upon receiving the access request from the terminal 10, the communication control apparatus 20A performs authentication processing based on the information about the terminal, the information about the user, and the information about the content of the service contained in the request. When having authenticated the terminal 10 as eligible, the communication control apparatus 20A delivers a policy to the server 31 of the service distributor 30 (S120). Upon receiving the delivered policy, the server 31 distributes the content of the service to the terminal 10 (S130).

On the other hand, when it is impossible to authenticate the terminal 10 as eligible only with the information contained in the access request from the terminal 10, the communication processing apparatus 20A requests the terminal 10 to further transmit detailed information (S110). Upon receiving this request for the detailed information transmission, the terminal 10 transmits the detailed information to the communication processing terminal 20. Upon receiving the detailed information from the terminal 10, the communication processing terminal 20A performs authentication processing based on information contained in the detailed information. When having authenticated the terminal 10 as eligible, the communication control apparatus 20A delivers a policy to the server 31 of the service distributor 30 (S120). Upon receiving the delivered policy, the server 31 distributes the content of the service to the terminal 10 (S130).

Also, when having. approved the access request from the terminal 10, the communication control apparatus 20A registers the user of the terminal 10 in a user authentication processing information database 243 of an authentication database. This user authentication processing information database 243 is synchronized with that of the other communication control apparatus 20B. In other words, the contents of the user authentication processing information database 243 registered in the communication control apparatus 20A are transmitted to the communication control apparatus 20B and the contents of the user authentication processing information database 243 of the communication control apparatus 20A and those of the communication control apparatus 20B are set identical to each other (S200). In this case, an encryption/decryption program 232 encrypts the user authentication processing information and the encrypted information is transmitted to the information control apparatus 20B. Then, an encryption/decryption program 232 of the information control apparatus 20B decrypts the encrypted information.

Next, a case where the terminal 10 has moved to be connected to the communication control apparatus 20B will be described.

After having connected to the communication control apparatus 20B, the terminal 10 transmits an access request to the communication control apparatus 20B (S210).

The communication control apparatus 20B receives the access request and judges whether the terminal 10 should be authenticated as eligible with reference to the received access request and the user authentication processing information.

The user authentication processing information database 243 of the communication control apparatus 20A and that of the communication control apparatus 20B have been set identical to each other. When information showing that the terminal 10 that transmitted the access request has already been authenticated as eligible by the communication control apparatus 20A is stored in the user authentication processing information 243 of the communication control apparatus 20B, the communication control apparatus 20B authenticates the terminal 10 as eligible. When having authenticated the terminal 10 as eligible, the communication control apparatus 20B delivers a policy to the server 31 of the service distributor 30 (S230). Upon receiving the delivered policy, the server 31 distributes the content of the service to the terminal 10 (S240).

Next, an operation of the distributed authentication system of this embodiment will be described.

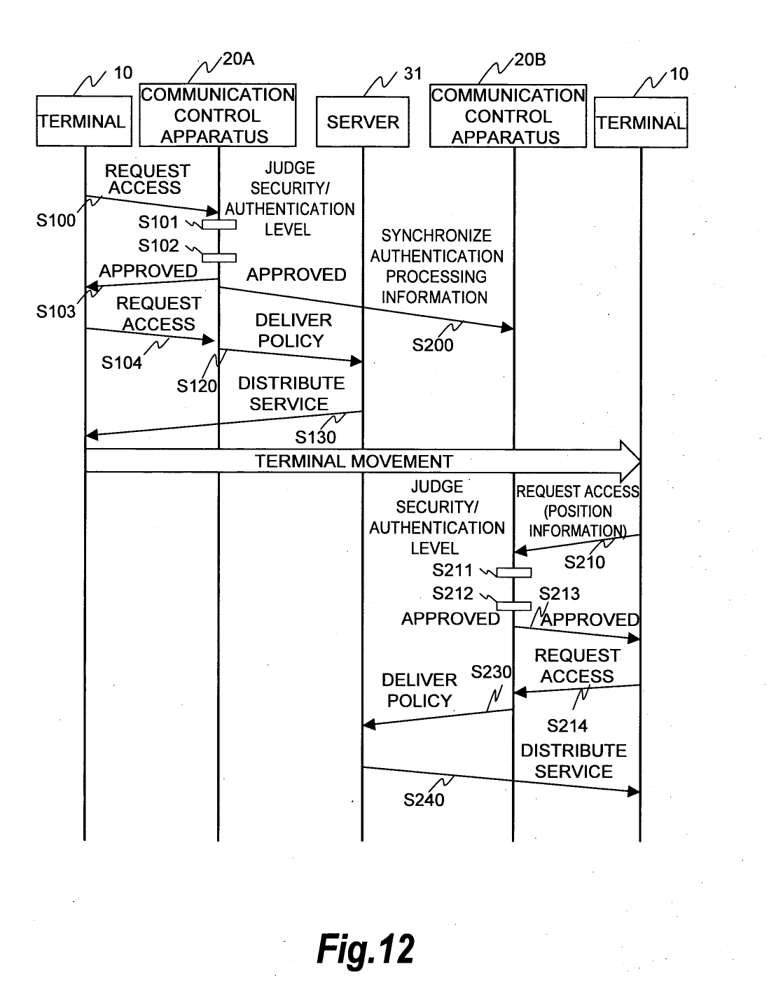

FIG. 12 is a sequence diagram of authentication processing according to this embodiment.

The sequence diagram of FIG. 12 shows processing in the case of service whose authentication level is low and which the user is capable of accessing without performing authentication.

The terminal 10 transmits an access request to the communication control apparatus 20A (S100). This access request contains information about the user of the terminal 10, information about the content of service for which the access request has been issued, information showing previous and current positions of the terminal 10, information showing whether the terminal 10 has already been authenticated, and the like.

The communication control apparatus 20A receives the access request through the I/F 21. The communication program 231 receives this access request, analyzes the contents thereof, and sends the request to the security/authentication level judgment program 233. The security/authentication level judgment program 233 judges whether the access should be permitted with reference to the contents of the access request (S101).

When the security/authentication level judgment program 233 has judged to approve the access request from the user without requesting additional information (S102), the communication program 231 transmits a notification showing that the access request has been approved to the terminal 10 through the I/F 21 (S103).

Upon receiving this access request approval, the terminal 10 transmits an access request to the communication control apparatus 20A (S104).

Also, when having approved the access request from the terminal 10, the communication control apparatus 20A registers the user of the terminal 10 in the user authentication processing information database 243 of the authentication database. This user authentication processing information database 243 is synchronized with that of the other communication control apparatus 20B. In other words, the contents of the user authentication processing information database 243 registered in the communication control apparatus 20A are transmitted to the communication control apparatus 20B and the contents of the user authentication processing information database 243 of the communication control apparatus 20A and those of the communication control apparatus 20B are set identical to each other (S200).

Upon receiving the access request from the user of the terminal 10 that has already been authenticated as eligible, the communication control apparatus 20A delivers a policy to the server 31 of the service distributor 30 (S120). This policy contains information about the content of the service requested by the user, a notification showing that the user has already been authenticated as eligible, and the address of the terminal 10 that issued the request.

Upon receiving the policy, the server 31 of the service distributor 30 distributes the service to the terminal 10 according to the contents of the policy (S130).

Next, when having moved to be connected to the communication control apparatus 20B, the terminal 10 transmits an access request to the communication control apparatus 20B (S210). This access request contains information showing previous and present positions of the terminal 10, information showing whether the terminal 10 has already been authenticated as eligible, and the like in addition to the information contained in the access request issued in step S100 described above.

The communication control apparatus 20B receives the access request through the I/F 21. The communication program 231 receives this, access request, analyzes the contents thereof, and sends the request to the security/authentication level judgment program 233. The security/authentication level judgment program 233 judges whether the access should be permitted with reference to the contents of the access request (S211).

The security/authentication level judgment program 233 refers to the synchronized user authentication processing information database 243. When judging that the user has already been authenticated as eligible, the security/authentication level judgment program 233 approves the access request (S212). Then, the communication program 231 transmits a notification showing that the access request has been approved to the terminal 10 through the I/F 21 (S213).

Upon receiving this access request approval, the terminal 10 transmits an access request to the communication control apparatus 20B (S214).

Upon receiving the access request from the user of the terminal 10, the communication control apparatus 20B delivers a policy to the server 31 of the service distributor 30 (S230). This policy contains information about the content of the service requested by the user, a notification showing that the user has already been authenticated as eligible, and the address of the terminal 10 that issued the request. Upon receiving the policy, the server 31 distributes the service to the terminal 10 according to the contents of the policy (S240).

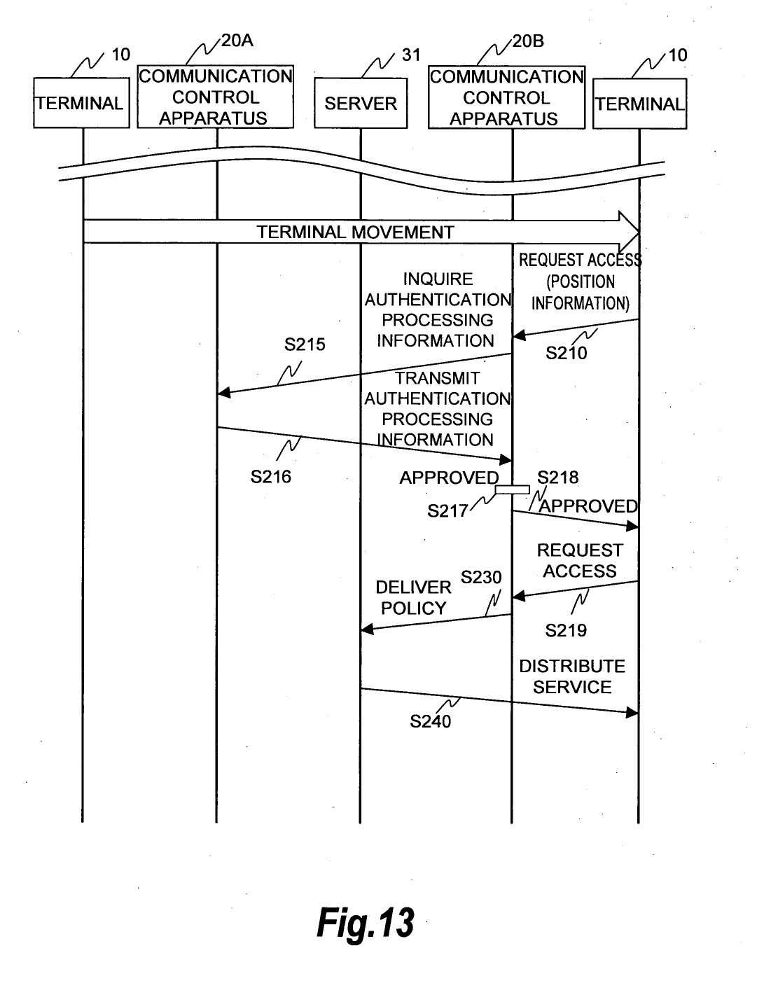

FIG. 13 is another sequence diagram of the authentication processing according to this embodiment.

Processing shown in FIG. 13 is processing in the case where when the terminal 10 has moved and transmitted an access request to the communication control apparatus 20B, the contents of the user authentication processing information database 243 of the communication control apparatus 20B have not yet been synchronized with those of the communication control apparatus 20A.

When having moved to be connected to the communication control apparatus 20B, the terminal 10 transmits an access request to the communication control apparatus 20B (S210). This access request contains information showing previous and present positions of the terminal 10, information showing whether the terminal 10 has already been authenticated as eligible, and the like in addition to the information contained in the access request issued in step S100 described above.

The communication control apparatus 20B receives the access request through the I/F 21. The communication program 231 receives this access request, analyzes the contents thereof, and sends the request to the security/authentication level judgment program 233.

The security/authentication level judgment program 233 first refers to the user authentication processing information database 243. When having judged that information about authentication of the user is not registered in the user authentication processing information database 243, the security/authentication level judgment program 233 refers to the position information contained in the received access request and acquires information about the communication control apparatus 20A in which authentication processing information has been registered at an immediately preceding position of the terminal 10. Then, the security/authentication level judgment program 233 inquires of the communication control apparatus 20A about the user authentication processing information (S215). This inquiry contains information about the user of the terminal 10 that issued the access request.

Upon receiving the authentication processing information inquiry from the communication control apparatus 20B, the communication control apparatus 20A acquires authentication processing information corresponding to the user information contained in the inquiry from the user authentication processing information database 243 of the authentication database 240. Then, the communication control apparatus 20A transmits the acquired authentication processing information to the communication control apparatus 20B (S216).

The communication control apparatus 20B receives the authentication processing information through the I/F 21. The communication program 231 receives this authentication processing information, analyzes the contents thereof, and transmits the information to the security/authentication level judgment program 233. The security/authentication level judgment program 233 refers to the authentication processing information and approves the access request without requesting additional information (S217). The communication program 231 transmits a notification showing that the access request has been approved to the terminal 10 through the I/F 21 (S218).

Upon receiving this access request approval, the terminal 10 transmits an access request to the communication control apparatus 20A (S219).

Upon receiving the access request from the user of the terminal 10 that has already been authenticated as eligible, the communication control apparatus 20B delivers a policy to the server 31 of the service distributor 30 (S230). This policy contains information about the content of the service requested by the user, a notification showing that the user has already been authenticated as eligible, and the address of the terminal 10 that issued the request.

Upon receiving the policy, the server 31 of the service distributor 30 distributes the service to the terminal 10 according to the contents of the policy (S240).

It should be noted that, instead of transmitting the position information, the terminal 10 may transmit information about a communication control apparatus at which the terminal 10 was authenticated as eligible in the past (S210). Upon receiving this access request, the communication control apparatus 20B acquires the information about the communication control apparatus contained in the access request and inquires of the communication control apparatus about information on the authentication of the terminal that issued the request.

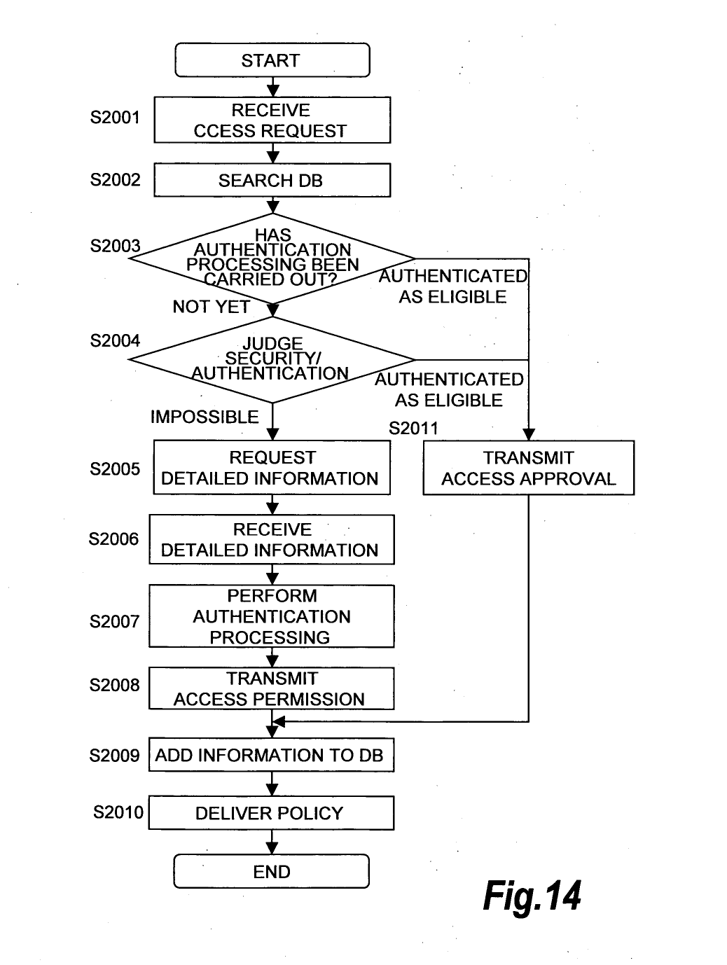

FIG. 14 is a flowchart of processing by the communication control apparatus 20B.

The communication control apparatus 20B receives an access request from the terminal 10 (S2001). This access request is sent to the communication program 231 through the I/F 21. The communication program 231 analyzes the contents of the access request and passes the request to the security/authentication level judgment program 233.

The security/authentication level judgment program 233 acquires information about a user, who issued the access request, and information about a content from the access request. Then, the security/authentication level judgment program 233 searches the user context information database 241 of the authentication database 240 and acquires information about the user. Also, the security/authentication level judgment program 233 searches the service content information database 242 of the authentication database 240 and acquires information about the content (S2002).

Next, the security/authentication level judgment program 233 judges whether the user of the terminal 10 that issued the access request has already been authenticated as eligible (S2002).

More specifically, first, the security/authentication level judgment program 233 judges whether the user of the terminal 10 that issued the access request has already been authenticated as eligible with reference to the user authentication processing information database 243 of the authentication database 240.

Also, when information about authentication processing of the user is not stored in the user authentication processing information database 243, the security/authentication level judgment program 233 refers to the position information contained in the received access request and acquires information about the communication control apparatus 20A in which information about authentication processing of the terminal 10 has been registered at an immediately preceding position. Then, the security/authentication level judgment program 233 inquires of the communication control apparatus 20A about the information on the authentication processing of the user. This inquiry contains information about the user of the terminal 10 that issued the access request.

The communication control apparatus 20B receives the authentication processing information from the communication control apparatus 20A through the I/F 21. The communication program 231 receives this authentication processing information, analyzes the contents thereof, and transmits the information to the security/authentication level judgment program 233. The security/authentication level judgment program 233 judges whether the user of the terminal 10 that issued the access request has already been authenticated as eligible with reference to the authentication processing information.

When having judged that the user of the terminal 10 that issued the access request has already been authenticated as eligible, the security/authentication level judgment program 233 approves the access request without performing authentication based on detailed information from the terminal 10. Then, a notification showing that the access request has been approved is transmitted to the terminal 10 (S2011). On the other hand, when it has been judged that the user of the terminal 10 that issued the access request has not yet been authenticated as eligible, the processing proceeds to step S2004.

The security/authentication level judgment program 233 calculates a product of a value of a security level of the user and a value of a security level of the content. Then, the security/authentication level judgment program 233 selects an authentication method, which is suited for the access request, with reference to the calculated value and the judgment table 234 (S2004).

When the access request has been approved with the selected authentication method without performing authentication based on detailed information from the terminal 10 (when the calculated value is “1”, for instance), a notification showing that the access request has been approved is transmitted to the terminal 10 (S2011).

On the other hand, when it is impossible to approve the access request with the selected authentication method without performing authentication based on detailed information from the terminal 10 (when the calculated value is “2” or more, for instance), detailed information corresponding to the selected authentication scheme 2342 is requested (S2005). For instance, when the selected authentication scheme is “password input”, a registered user name and password are requested. Therefore, the communication control apparatus 20 transmits a detailed information request to the terminal 10 (S2005). More specifically, the security/authentication level judgment program 233 sends a detailed information request to the communication program 231. The communication program 231 transmits the received detailed information request to the terminal 10 through the I/F 21.

Upon receiving the detailed information request, the terminal 10 transmits detailed information corresponding to the request to the communication control apparatus 20. For instance, when the selected authentication scheme is “password input”, a program of the terminal 10 prompts the user to input his/her user name and password. Upon receiving the input from the user, the terminal 10 transmits the detailed information to the communication control apparatus 20.

The communication control apparatus 20 receives the detailed information from the terminal 10. This detailed information is sent to the communication program 231 through the I/F 21. The communication program 231 analyzes the contents of the received detailed information and sends the information to the security/authentication level judgment program 233.

Upon receiving the detailed information (S2006), the security/authentication level judgment program 233 carries out authentication processing based on the information (S2007). More specifically, the security/authentication level judgment program 233 authenticates the user of the terminal 10 by checking the detailed information against information prestored in the database 24 based on the authentication scheme selected in step S2004.

When having approved the access request, the security/authentication level judgment program 233 transmits a notification showing that the access request has been approved to the terminal 10 (S2008).

After having transmitted the access request approval notification in step S2008 or step S2011, the security/authentication level judgment program 233 registers the user authenticated as eligible and a corresponding authentication level in the user authentication processing information database 243 of the authentication database 240 (S2009).

Next, the security/authentication level judgment program 233 delivers a policy to the server 31 of the content provider 30 that provides the content requested by the user of the terminal 10 (S2010). Upon receiving the policy, the server 31 provides the terminal 10 with the content of the service according to the contents of the policy.

As described above, in the second embodiment of this invention, the user authentication processing information of a plurality of communication control apparatuses 20 is set identical to each other through synchronization, so even when the terminal 10 of the user has moved, it becomes possible for the user to receive the service from the service distributor without performing authentication again. Also, when information showing that the user has already been authenticated as eligible is not stored in the communication control apparatus 20 to which the terminal 10 has moved to be connected, the communication control apparatus 20 finds the communication control apparatus 20, with which the terminal 10 communicated in the past, based on information showing a previous position of the terminal 10 and inquires of the found communication control apparatus 20 about authentication processing information, so even when the terminal 10 has moved, it becomes possible for the user to receive the service provided by the service distributor without performing authentication again in a like manner.

It should be noted that time information may be given to the information stored in the user authentication processing information database 243. In this case, when an access request is received from the terminal 10 again, when a predetermined time has passed from previous authentication, authentication processing is requested again. By setting a term of validity for authentication in this manner, it becomes possible to further enhance security of the authentication.

### Third Embodiment

Next, a distributed authentication system according to a third embodiment of this invention will be described.

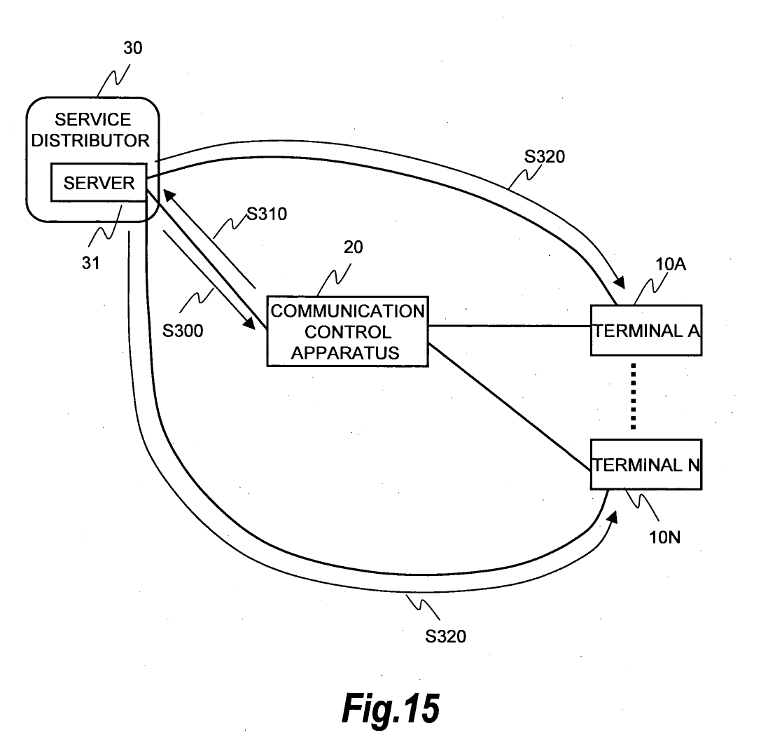

FIG. 15 is a construction diagram of the distributed authentication system according to the third embodiment of this invention.

In the distributed authentication system of this embodiment, a terminal 10 (10A to 10N), communication control apparatuses 20 and a service distributor 30 are connected to each other through a network.

It should be noted that the terminal 10 (10A to 10N), the communication control apparatuses 20 and the service distributor 30 are the same as those of the first embodiment described above, so the description thereof will be omitted.

Also, a server 31 of the service distributor 30 is constructed so that it is capable of distributing service to the plurality of terminals 10A to 10N at the same time using a broadcast or multicast technique.

The server 31 of the service distributor 30 transmits a distribution request to the communication control apparatus 20 (S300). This distribution request contains information about the terminals 10 that are distribution destinations, information about users of the terminals 10, and information about a content to be distributed.

Upon receiving the distribution request from the service distributor 30, the communication control apparatus 20 performs authentication processing based on the information about the terminals, the information about the users, and the information about the content of the service contained in the distribution request. When having permitted the distribution to the terminals 10 designated by the request, the communication control apparatus 20 transmits a notification showing that the distribution has been permitted to the server 31 of the service distributor 30 (S310). Upon receiving this distribution permission notification, the server 31 of the service distributor 30 distributes the content of the service to the terminals 10 (S320).

On the other hand, when it is impossible to permit the distribution only with the information contained in the distribution request, the communication processing apparatus 20 requests the server 31 of the service distributor 30 to further transmit detailed information.

Upon receiving this detailed information transmission request, the server 31 of the service distributor 30 transmits detailed information to the communication processing terminal 20. Upon receiving the detailed information, the communication processing terminal 20 performs authentication processing based on information contained in the detailed information. When having permitted the distribution to the terminals 10 designated by the request, the communication control apparatus 20 transmits a notification showing that the distribution has been permitted to the server 31 of the service distributor 30 (S310). Upon receiving this distribution permission notification, the server 31 of the service distributor 30 distributes the content of the service to the terminals 10 (S320).

Next, an operation of the distributed authentication system according to this embodiment will be described.

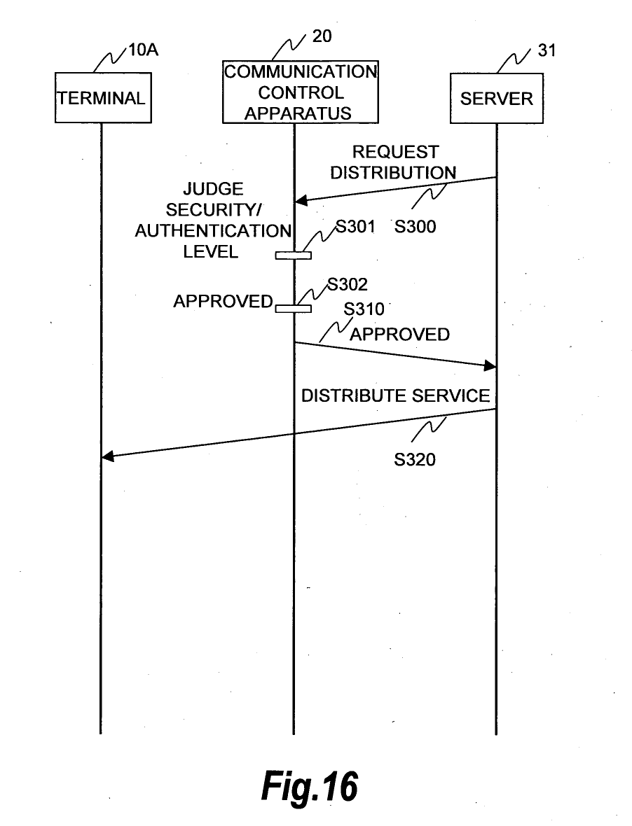

FIG. 16 is a sequence diagram of authentication processing according to this embodiment.

The sequence diagram of FIG. 16 shows processing in the case of service whose authentication level is low and which the user is capable of accessing without performing authentication.

The server 31 of the service distributor 30 transmits a distribution request to the communication control apparatus 20 (S300). This distribution request contains information about the terminal 10 serving as a distribution destination, information about the user of the terminal 10, information about the content of service for which the access request has been issued, and the like.

The communication control apparatus 20 receives the distribution request through the I/F 21. The communication program 231 receives this distribution request, analyzes the contents thereof, and sends the request to the security/authentication level judgment program 233. The security/authentication level judgment program 233 judges whether the access should be permitted with reference to the contents of the distribution request (S301).

When the security/authentication level judgment program 233 has approved the distribution request of the terminal 10 distribution information without requesting additional information (S302), the communication program 231 transmits a notification showing that the distribution request has been approved to the server 31 of the service distributor 30 through the I/F 21 (S310).

Upon receiving this permission, the server 31 of the service distributor 30 distributes the service to the terminals 10 designated by the distribution request (S320).

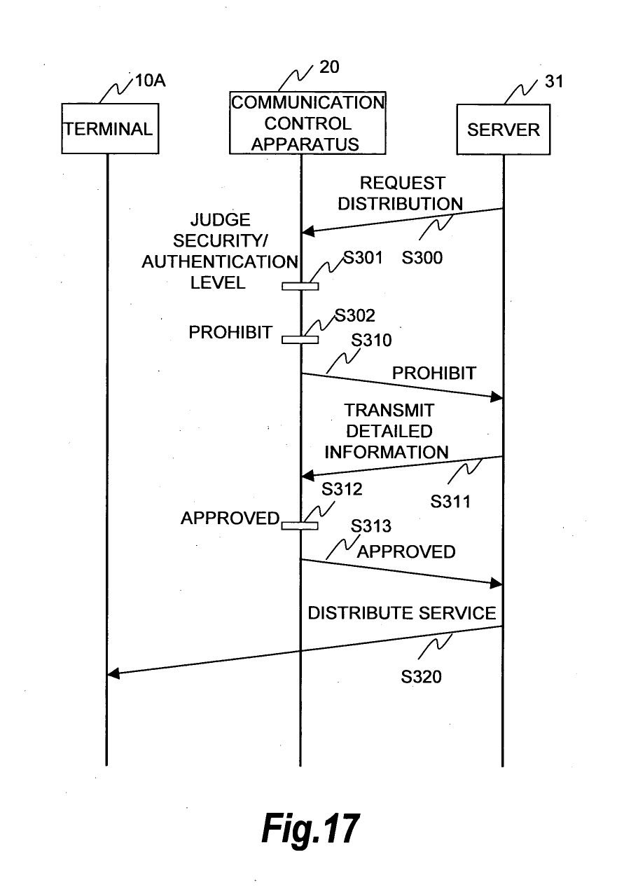

FIG. 17 is another sequence diagram of the authentication processing according to this embodiment.

The sequence diagram of FIG. 17 shows processing in the case of service whose authentication level is high and which requires detailed information for authentication.

The server 31 of the service distributor 30 transmits a distribution request to the communication control apparatus 20 (S300). This distribution request contains information about the terminal 10 serving as a distribution destination, information about the user of the terminal 10, information about the content of service for which the access request has been issued, and the like.

The communication control apparatus 20 receives the distribution request through the I/F 21. The communication program 231 receives this distribution request, analyzes the contents thereof, and sends the request to the security/authentication level judgment program 233. The security/authentication level judgment program 233 judges whether the access should be permitted with reference to the contents of the distribution request (S301).

When the security/authentication level judgment program 233 has decided that the terminals 10 designated by the distribution request are prohibited (S302), the communication program 231 transmits a detailed information request to the server 31 of the service distributor 30 through the I/F 21 (S310).

Upon receiving this detailed information request, the server 31 of the service distributor 30 transmits the detailed information to the communication control apparatus 20 (S311).

Upon receiving this detailed information, the security/authentication level judgment program 233 of the communication control apparatus 20 authenticates the terminals 10 designated by the distribution request again with reference to the contents of the detailed information.

When the security/authentication level judgment program 233 has authenticated the terminals 10 designated by the distribution request as eligible (S312), the communication program 231 transmits a notification showing that the distribution has been permitted to the server 31 of the service distributor 30 through the I/F 21 (S313).

Upon receiving this permission, the server 31 of the service distributor 30 distributes the service to the terminals 10 designated by the distribution request (S320).

As described above, in the third embodiment of this invention, when a service distributor 30 side distributes service to the terminals, it transmits a distribution request to the communication control apparatus 20. The communication control apparatus 20 authenticates this distribution request, so the service from the service distributor 30 to the terminals 10 can be permitted. It should be noted that authentication processing performed to judge whether the distribution should be permitted is approximately the same as that of the first embodiment.

### Fourth Embodiment

Next, a distributed authentication system according to a fourth embodiment of this invention will be described.

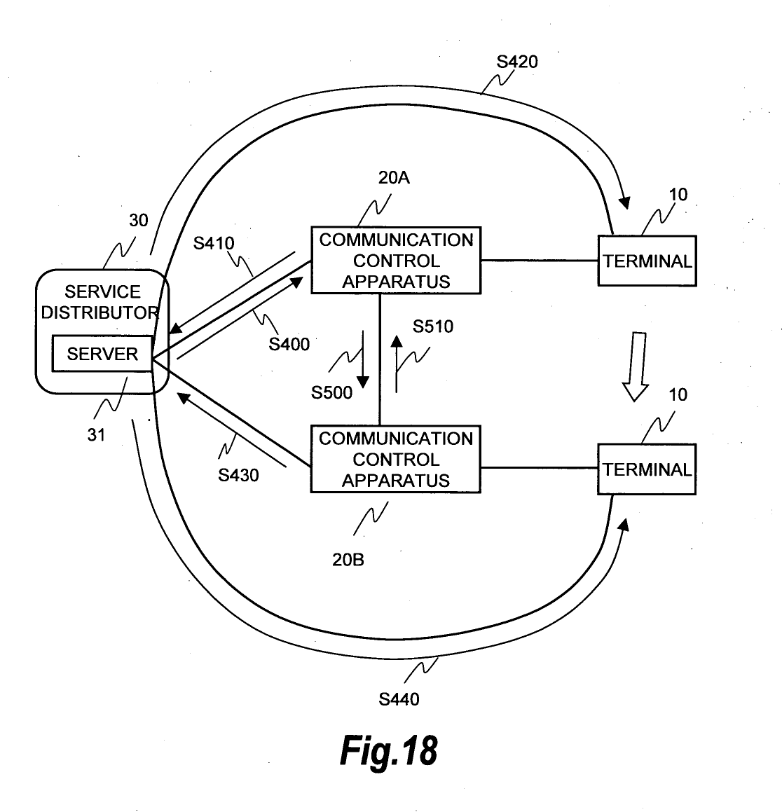

FIG. 18 is a construction diagram of the distributed authentication system according to the fourth embodiment of this invention.

In the distributed authentication system of this embodiment, a terminal 10, communication control apparatuses 20 (20A and 20B), and a server 31 of a service distributor 30 are connected to each other through a network.

It should be noted that the terminal 10, the communication control apparatuses 20 (20A and 20B), and the server 31 of the service distributor 30 are the same as those of the first embodiment described above, so the description thereof will be omitted.

Also, the terminal 10 is constructed so that it is movable and is capable of connecting to and communicating with each of the communication control apparatuses 20A and 20B.

An operation of the distributed authentication system according to the fourth embodiment will be described.

Processing in the case where the service distributor 30 requests service distribution is the same as that of the third embodiment described above.

In other words, the server 31 of the service distributor 30 transmits a distribution request to the communication control apparatus 20A (S400). This distribution request contains information about the terminals 10 that are distribution destinations, information about users of the terminals 10, and information about a content to be distributed.

Upon receiving the distribution request from the server 31, the communication control apparatus 20A performs authentication processing based on the information about the terminals, the information about the users, and the information about the content of the service contained in the distribution request. When having permitted the distribution to the terminals 10 designated by the request, the communication control apparatus 20A transmits a notification showing that the distribution has been permitted to the server 31 of the service distributor 30 (S410). Upon receiving this distribution permission notification, the server 31 of the service distributor 30 distributes the content of the service to the terminals 10 (S420).

On the other hand, when it is impossible to permit the distribution only with the information contained in the distribution request, the communication processing apparatus 20A requests the server 31 of the service distributor 30 to further transmit detailed information (S410).

Upon receiving this detailed information transmission request, the server 31 of the service distributor 30 transmits the detailed information to the communication processing terminal 20. Upon receiving the detailed information, the communication processing terminal 20A performs authentication processing based on information contained in the detailed information. When having permitted the distribution to the terminals 10 designated by the request, the communication control apparatus 20A transmits a notification showing that the distribution has been permitted to the server 31 of the service distributor 30. Upon receiving this distribution permission notification, the server 31 distributes the content of the service to the terminals 10 (S420).

Next, a case where the terminal 10 has moved to be connected to the communication control apparatus 20B will be described.

After having connected to the communication control apparatus 20A, the server 31 of the service distributor 30 transmits a distribution request to the communication control apparatus 20A, in a like manner (S400).

The communication control apparatus 20A receives the distribution request and judges whether the terminal 10 should be authenticated as eligible with reference to the received distribution request and the user authentication processing information.

The terminal 10 designated by the distribution request does not currently connect to the communication control apparatus 20A. Therefore, the security/authentication level judgment program 233 inquires of the communication control apparatus 20B, to which the terminal 10 currently connects, about user authentication processing information (S500).

Upon receiving the authentication processing information inquiry from the communication control apparatus 20A, the communication control apparatus 20B acquires authentication processing information corresponding to the user information contained in the inquiry from the user authentication processing information database 243 of the authentication database 240. Then, the communication control apparatus 20B transmits the acquired authentication processing information to the communication control apparatus 20A (S510).

Upon receiving the distribution request from the service distributor 30, is processed based on the information about the terminal, the information about the user, and information about the content of the service contained in the distribution request. When having permitted the distribution to the terminal 10 designated by the request transmission of a notification showing that the distribution has been permitted to the server 31 of the service distributor 30 is sent (S430). Upon receiving this distribution permission notification, the server 31 distributes the content of the service to the terminal 10 (S440).

Next, an operation of the distributed authentication system according to this embodiment will be described.

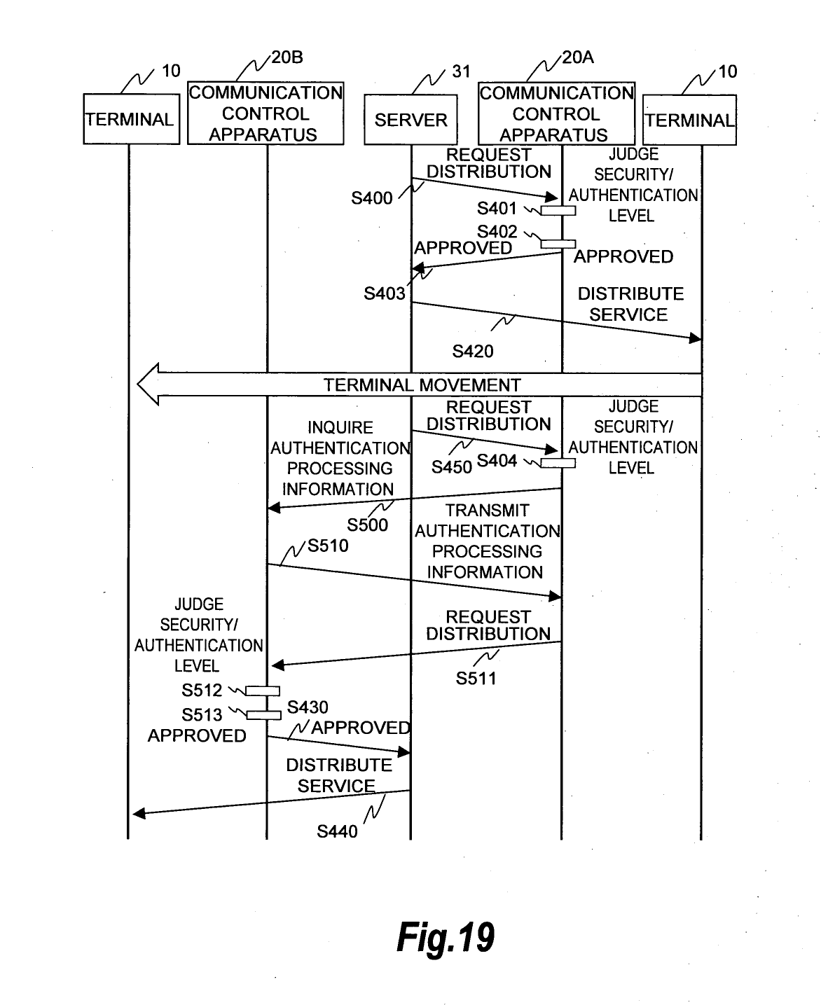

FIG. 19 is a sequence diagram of authentication processing according to this embodiment.

The sequence diagram of FIG. 19 shows processing in the case of service whose authentication level is low and which the user is capable of accessing without performing authentication.

The server 31 of the service distributor 30 transmits a distribution request to the communication control apparatus 20 (S400). This distribution request contains information about the terminal 10 serving as a distribution destination, information about the user of the terminal 10, information about the content of service for which the access request has been issued, and the like.

The communication control apparatus 20 receives the distribution request through the I/F 21. The communication program 231 receives this distribution request, analyzes the contents thereof, and sends the request to the security/authentication level judgment program 233. The security/authentication level judgment program 233 judges whether the access should be permitted with reference to the contents of the distribution request (S401).

When the security/authentication level judgment program 233 has approved the distribution request of the terminal 10 distribution information without requesting additional information (S402), the communication program 231 transmits a notification showing that the distribution request has been approved to the server 31 of the service distributor 30 through the I/F 21 (S403).

Upon receiving this permission, the server 31 of the service distributor 30 distributes the service to the terminals 10 designated by the distribution request (S420).

Next, a case where the terminal 10 has moved to be connected to the communication control apparatus 20B will be described.

The server 31 of the service distributor 30 transmits a distribution request to the communication control apparatus 20A (S450).

The communication control apparatus 20A receives the distribution request through the I/F 21. The communication program 231 receives this distribution request, analyzes the contents thereof, and sends the request to the security/authentication level judgment program 233. The security/authentication level judgment program 233 is executed with reference to the contents of the distribution request (S404).

The terminal 10 designated by the distribution request does not currently connect to the communication control apparatus 20A. Therefore, the security/authentication level judgment program 233 inquires of the communication control apparatus 20B, to which the terminal 10 currently connects, about user authentication processing information (S500). This inquiry contains information about the user of the terminal 10 designated by the distribution request.

Upon receiving the authentication processing information inquiry from the communication control apparatus 20A, the communication control apparatus 20B acquires authentication processing information corresponding to the user information contained in the inquiry from the user authentication processing information database 243 of the authentication database 240. Then, the communication control apparatus 20B transmits the acquired authentication processing information to the communication control apparatus 20A (S510).

The communication control apparatus 20B receives the authentication processing information through the I/F 21. The communication program 231 receives this authentication processing information, analyzes the contents thereof, and transmits the information to the security/authentication level judgment program 233. The security/authentication level judgment program 233 transmits the distribution request transmitted from the server 31 of the service distributor 30 to the communication control apparatus 20B with reference to the authentication processing information. In other words, the communication program 231 of the communication control apparatus 20A transmits the distribution request to the communication control apparatus 20B through the I/F 21 (S511).

Upon receiving the distribution request from the server 31, the security/authentication level judgment program 233 of the communication control apparatus 20A performs authentication processing based on the information about the terminal, the information about the user, and the information about the content of the service contained in the distribution request (S512). When having permitted the distribution to the terminal 10 designated by the request (S513), the security/authentication level judgment program 233 transmits a notification showing that the distribution has been permitted to the server 31 of the service distributor 30 (S430). Upon receiving this distribution permission notification, the server 31 distributes the content of the service to the terminal 10 (S440).

As described above, in the fourth embodiment of this invention, the user authentication processing information in a plurality of communication control apparatuses 20 is set identical to each other through synchronization, so when the service distributor 30 distributes the service to the terminal 10, even when the terminal 10 has moved, it becomes possible for the service distributor 30 to distribute the service without performing authentication again. Also, when the terminal 10 has moved, the communication control apparatus 20, to which the terminal 10 currently connects, is found and an authentication processing information inquiry is made to the found communication control apparatus 20, so even when the terminal 10 has moved, it becomes possible for the service distributor 30 to distribute the service without performing authentication again in a like manner.

### Fifth Embodiment

Next, a distributed authentication system in a fifth embodiment of this invention will be described.

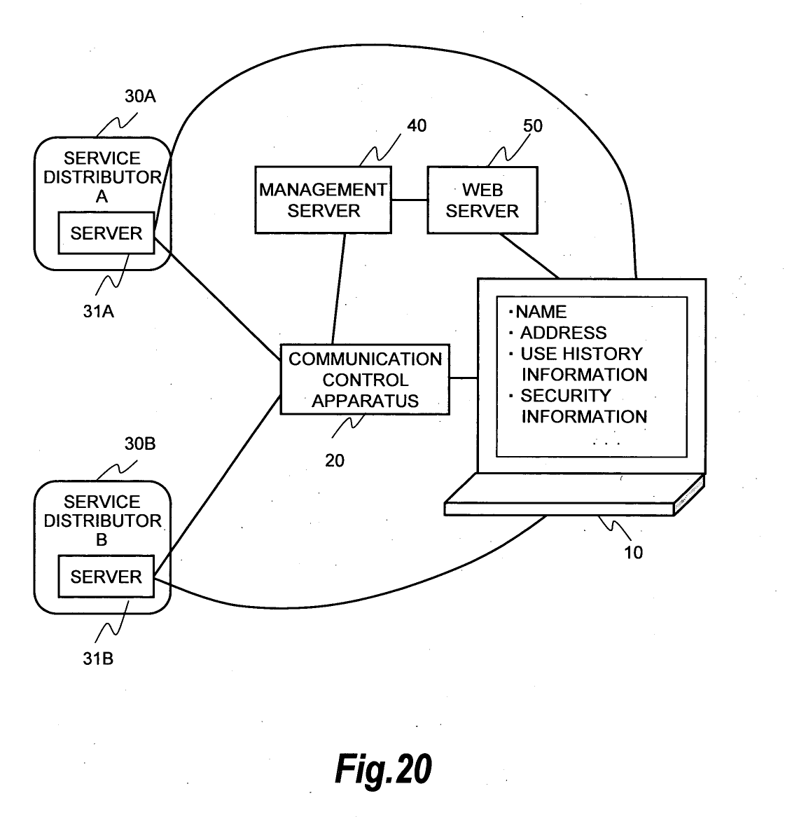

FIG. 20 is a construction diagram of the distributed authentication system according to the fifth embodiment of this invention.

It is required that the user context information 241 stored in the authentication database 240 of the communication control apparatus 20 is registered in advance before authentication processing is performed.

Therefore, a Web server 40 and a management server 50 are provided in the distributed authentication system.

The Web server 40 includes a program and provides a terminal 10 that accesses the Web server 40 with a Web page. The management server 50 includes a program, acquires user context information registered by the terminal 10, and registers the acquired user context information in the communication control apparatus 20.

More specifically, the terminal 10 accesses the Web server 40 with reference to an address of the server 40. Then, the terminal 10 receives a portal site provided by the Web server 40 and displays the site. Next, a user operating the terminal 10 inputs his/her user context information according to instructions on the displayed portal site. Examples of the inputted user context information include the name, address, age, use history, and security information of the user.

When the user has inputted the user context information into the portal site provided by the Web server 40 and has issued a registration instruction, a notification is sent to the management server.

The management server 50 acquires the user context information inputted to the portal site provided by the Web server 40 and transmits the information to the communication control apparatus 20. The communication control apparatus 20 registers the user context information in the user context information database 241 of the authentication database 240.

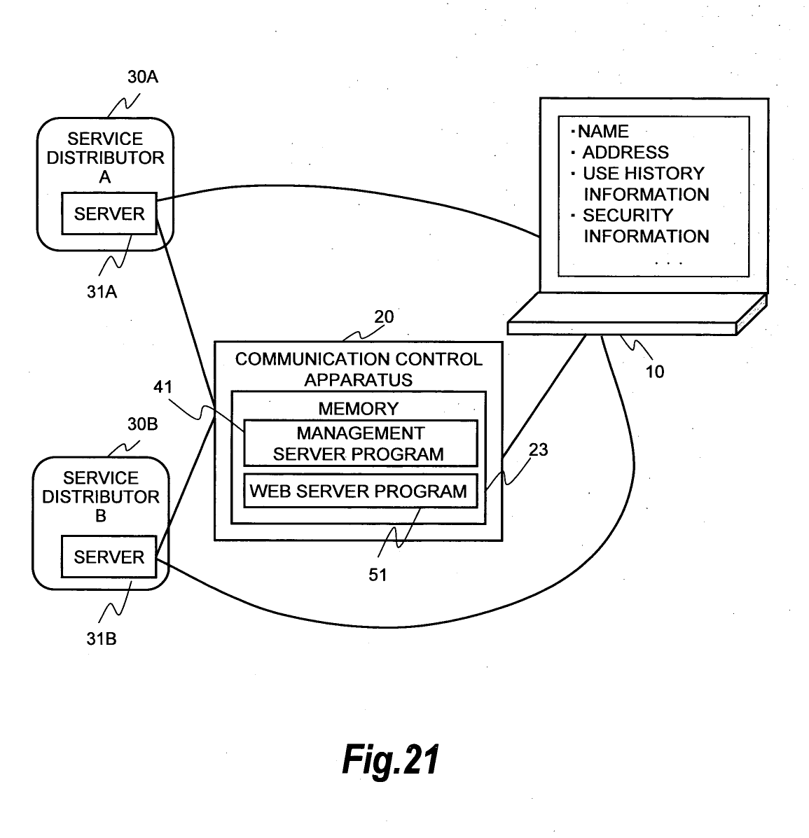

FIG. 21 is another construction diagram of the distributed authentication system according to the fifth embodiment of this invention.

In this drawing, instead of providing the functions of the Web server 40 and the management server 50 as independent servers, a Web server program 41 having the function of the Web server 40 and a management server program 51 having the function of the management server 50 are stored in the communication control apparatus 20.

As described above, the terminal 10 accesses a portal site provided by the Web server program 41 of the communication control apparatus 20 and the user inputs his/her user context information. When the user has inputted the user context information into the portal site provided by the Web server program 41 and has issued a registration instruction, a notification is sent to the management server program 51.

The management server program 51 acquires the user context information inputted in the portal site provided by the Web server program 41 and registers the information in the user context information database 241 of the authentication database 240.

As described above, in the fifth embodiment of this invention, it becomes possible to register the user context information in the communication control apparatus 20 through operations from the terminal 10.

It should be noted that a construction may be used instead in which the user context information is registered not by the user operating the terminal 10 but by an administrator at the service distributor 30.

While the present invention has been described in detail and pictorially in the accompanying drawings, the present invention is not limited to such detail but covers various obvious modifications and equivalent arrangements, which fall within the purview of the appended claims.

What is claimed is:

1. A distributed authentication system, comprising:
a terminal;
a communication control apparatus; and
a server for distributing a service,
the terminal, the communication control apparatus, and the server being connected to one another through a communication network,
the communication control apparatus controlling communication between the terminal and the server, wherein:
the communication control apparatus comprises a judgment module for judging whether to approve an access request from the terminal to the server; and
the judgment module calculates a security level for the access request, requests the terminal to retrieve detailed information corresponding to the calculated security level, and approves the access request by authenticating the terminal of an access request source based on the detailed information received from the terminal.

2. A communication control apparatus for controlling communication between a terminal and a server for distributing a service that are connected to each other through a communication network, comprising a judgment module for judging whether to approve an access request from the terminal to the server,
wherein the judgment module:
calculates a security level for the access request;
requests the terminal to retrieve detailed information corresponding to the calculated security level; and
approves the access request by authenticating the terminal of an access request source based on the detailed information received from the terminal.

3. The communication control apparatus according to claim 2, wherein when the calculated security level is lower than a predetermined value, the judgment module approves the access request without requesting the retrieval of the detailed information.

4. The communication control apparatus according to claim 2, further comprises a database, which is accessed by the communication control apparatus, for storing information about a user of the terminal and information about the service; wherein:
the judgment module:
calculates the security level from the information about the user and the information about the service, which are corresponding to the access request;
determines an authentication method for the terminal based on the calculated security level;
requests the terminal to retrieve detailed information corresponding to the determined authentication method; and
approves the access request by authenticating the terminal based on the detailed information received from the terminal.

5. The communication control apparatus according to claim 2, wherein:
when having approved the access request, the judgment module transmits a notification to that effect to the server; and
upon receiving the notification, the server provides the terminal with the service.

6. The communication control apparatus according to claim 4, wherein:
a plurality of communication control apparatuses are connected to the communication network; and
the judgment module:
stores, when having judged whether to approve the access request should be approved by authenticating the terminal based on the detailed information received from the terminal, information showing whether the terminal has been authenticated as eligible in the database;
transmits the stored information to another communication control apparatus;
stores, when having received information showing whether the terminal has been authenticated as eligible from another communication control apparatus, the information in the database; and
judges whether to approve the access request using the information received from the other communication control apparatus and stored in the database.

7. The communication control apparatus according to claim 6, wherein the judgment module has an encryption module for encrypting information to be transmitted to another communication control apparatus.

8. The communication control apparatus according to claim 2, wherein after a first access request has been approved through the authentication of the terminal, when a second access request has been transmitted from the same terminal, the judgment module approves the second access request when a security level of an authentication method for the second access request is lower than a security level of an authentication method that has been used to approved the first access request.

9. The communication control apparatus according to claim 8, wherein the judgment module:
calculates, when the second access request is transmitted from the terminal after a predetermined time has passed since the first access request is approved by authenticating the terminal of the access request source, a security level for the second access request;
requests the terminal to retrieve detailed information corresponding to the security level calculated for the second access request; and
approves the second access request by authenticating the terminal of the access request source based on the detailed information retrieved from the terminal.

10. The communication control apparatus according to claim 2, wherein:
a plurality of communication control apparatuses are connected to the communication network; and
the judgment module:
identifies, when information showing a past position of the terminal is contained in the access request, a communication control apparatus corresponding to the position;
inquires of the identified communication control apparatus about information on authentication of the terminal of the access request source; and
approves the access request when a result of the inquiry shows that the terminal of the access request source has been authenticated as eligible at the identified communication control apparatus.

11. The communication control apparatus according to claim 2, wherein:
a plurality of communication control apparatuses are connected to the communication network; and
the judgment module:
inquires, when information about a communication control apparatus that has authenticated the terminal and information about a method for the authentication are contained in the access request, of the communication control apparatus about information on the authentication of the terminal of the access request source; and
approves the access request by the terminal of the access request source when a result of the inquiry shows that the terminal has been authenticated as eligible at the communication control apparatus.

12. The communication control apparatus according to claim 3, wherein:
a Web server, into which the information about the user can be inputted, and a management server, which transmits the information about the user inputted into the Web server to the communication control apparatus, are connected to the communication network; and
the information about the user received from the management server is stored in the database.

13. The communication control apparatus according to claim 3, further comprising:
a Web server module into which the information about the user can be inputted; and
a management server module for storing the information about the user inputted into the Web server module in the database,
wherein the management server module stores the information about the user inputted into the Web server module in the database.
